(19) United States
(12) Patent Application Publication
(10) Pub. No.: US 2009/0046038 A1
(43) Pub. Date: Feb. 19, 2009

(54) Control method and electronic system utilizing the same

(75) Inventors: Chih-Hsun Weng, Yonghe City (TW); I-Chun Lai, Taiping City (TW); Sheng-Feng Huang, Miaoli City (TW)

Correspondence Address: LIU & LIU, 444 S. FLOWER STREET, SUITE 1750, LOS ANGELES, CA, 90071, US

(73) Assignee: TPO Displays Corp.

(21) Appl. No.: 12/220,227

(22) Filed: Jul. 22, 2008

(30) Foreign Application Priority Data
Aug. 16, 2007 (TW) 096130306

(51) Int. Cl. G09G 3/20

(52) U.S. Cl. 345/55

(57) ABSTRACT

A control method applied to a display panel including a gate driver, a source driver, and a plurality of pixel units. Each pixel unit includes a storage capacitor. At a first time point, a scan signal is provided by the gate driver. At a second time point following the first time point, at least one data signal is provided by the source driver. The storage capacitor stores a corresponding voltage according to the data signal and a common voltage. At the second time point, the common voltage is stable.

### BACKGROUND OF THE INVENTION

1. Field of the Invention

The invention relates to a control method, and more particularly to a control method for a display panel.

2. Description of the Related Art

Because cathode ray tubes (CRTs) are inexpensive and provide high definition, they are utilized extensively in televisions and computers. With technological development, flat-panel displays have gradually replaced CRT devices. When a larger display panel is required, the weight of the flat-panel display does not substantially change. Generally, flat-panel displays comprise liquid crystal displays (LCD), plasma display panels (PDP), organic electroluminescent displays (OLED), and field emission displays (FED)

Taking an LCD as an example, voltage polarity changes to avoid the liquid crystal component to continuously receive a same polarity. A conventional method controls the level of a common voltage (VCOM) to change the voltage polarity. When the temperature is lower, the common voltage enters a stable state after an extended period of time. If the common voltage is unstable, the image displayed in the LCD contains band appearances as shown as FIG. 1.

### BRIEF SUMMARY OF THE INVENTION

Control methods are provided. An exemplary embodiment of a control method for a display panel comprising a gate driver, a source driver, and a plurality of pixel units is described in the following. A scan signal is provided by the gate driver at a first time point. At least one data signal is provided at a second time point. Each pixel unit comprises a storage capacitor. The storage capacitor stores a voltage according to a difference between the data signal and a common signal, and the common signal is stable at the second time point.

Electronic systems are also provided. An exemplary embodiment of an electronic system comprises a gate driver, a source driver, and a plurality of pixel units. The gate driver provides a scan signal at a first time point. The source driver provides a data signal at a second time point. The first time point is different from the second time point. Each pixel unit stores a voltage according to the difference between the data signal and a common signal. The common signal is stable at the second time point.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an image; and

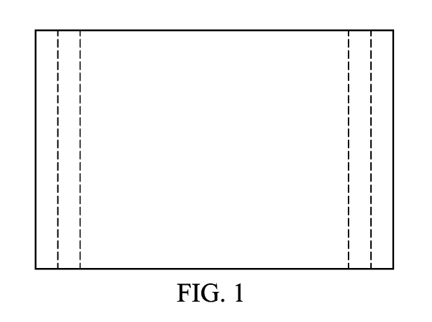

FIG. 2 is a schematic diagram of an exemplary embodiment of an electronic system;

FIG. 3 is a schematic diagram of an exemplary embodiment of a display panel; and

FIG. 4 is a timing chart of an exemplary embodiment of the display panel.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

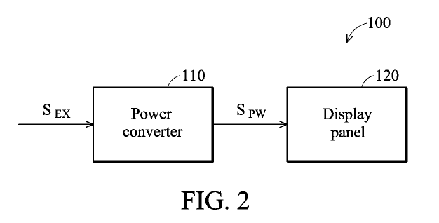

FIG. 2 is a schematic diagram of an exemplary embodiment of an electronic system. The electronic system 100 is a personal digital assistant (PDA), a mobile phone, a digital camera (DSC), a television, a global positioning system (GPS), a car display, an avionics display, digital photo frame, a notebook computer (NB), or a personal computer (PC). Referring to FIG. 2, the electronic system 100 comprises a power converter 110 and a display panel 120. The power converter 110 transforms an external signal S_{EX} into a power signal S_{PW}. The display panel 120 receives the power signal S_{PW} and displays images.

The external signal S_{EX} is an alternating current (AC) signal or a direct current (DC) signal. In this embodiment, the external signal S_{EX} is an AC signal. Thus, the power converter 110 transforms the external signal S_{EX} comprising AC type into the power signal S_{PW} comprising DC type. In some embodiments, the external signal S_{EX} is provided by a battery (not shown) or is a DC signal provided by other devices. The power converter 110 transforms the voltage level of the external signal S_{EX} comprising DC type and provides the transformed result to the display panel 120.

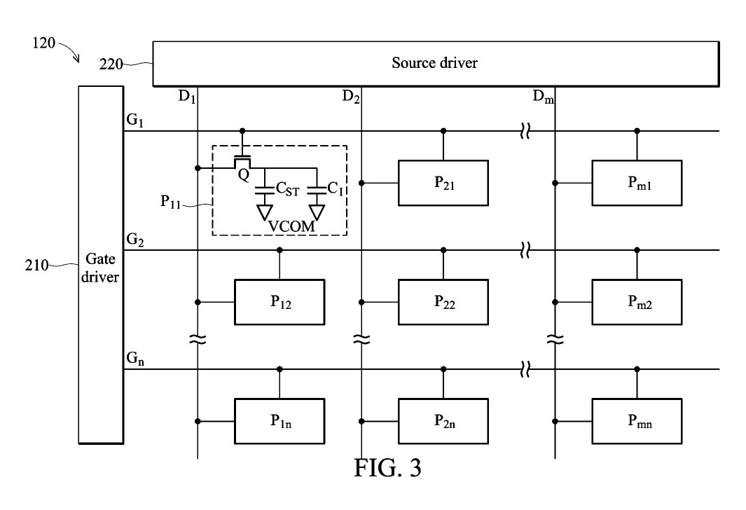

FIG. 3 is a schematic diagram of an exemplary embodiment of a display panel. The display panel 120 comprises a gate driver 210, a source driver 220,-and pixel units P₁₁˜Pₘₙ. The gate driver 210 provides scan signals to scan line G₁˜Gₙ. The source driver 220 provides data signals to data lines D₁˜Dₘ. For reducing cost, the source driver 220 is an integrated circuit (IC). The pin count of the IC is lower. Thus, only a portion of pins receive the data signal and others do not receive the data signals. For example, the source driver 220 provides data signals to data lines D₁˜D₂₄ and then provides data signals to data lines D₂₅˜D₄₈, and so forth.

Each of the pixel units receives the corresponding data signal according to the corresponding scan signal. Generally, each pixel unit comprises a storage capacitor. When a pixel unit receives a data signal, the storage capacitor stores a voltage according to the difference between the received data signal and a common signal. For example, when the gate driver 210 provides a scan signal to the scan line G, the driving transistor Q of the pixel unit P₁₁ is turned on. Thus, the storage capacitor C_{ST} stores a corresponding voltage according to the difference between the data signal of the data line D₁ and a common signal VCOM. Since the operations of pixel units P₁₁˜Pₘₙ are then same, the pixel unit P₁₁ is given as an example for brevity.

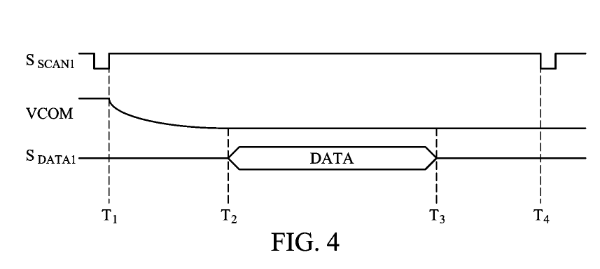

FIG. 4 is a timing chart of an exemplary embodiment of the display panel. Taking the pixel unit P₁₁ as an example, the gate driver 210 provides a scan signal S_{SCAN1} to the scan line G₁ at a time point T₁. The source driver 220 provides a data signal S_{DATA1} to the data line D₁ at a time point T₂. Since the common signal VCOM is stable at the time point T₂, the storage capacitor of the pixel unit P₁₁ stores the corresponding voltage according to the difference between the data signal S_{DATA1} and the stable common signal VCOM. The difference between the time points T₁ and T₂ exceeds 10 μs. In this embodiment, the difference between the f time points T₁ and T₂ is 10 μs.

The source driver 220 stops providing the data signal S_{DATA1} to the data line D₁ at a time point T₃. The gate driver 210 stops providing the scan signal S_{SCAN1} to the scan line GI at a time point T₄. The difference between the time points T₃ and T₄ exceeds 15 μs. In this embodiment, the difference between the f time points T₃ and T₄ is 15 μs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method for a display panel comprising a gate driver, a source driver, and a plurality of pixel units, wherein each pixel unit comprises a storage capacitor, comprising:
providing a scan signal by the gate driver at a first time point; and
providing at least one data signal at a second time point;
wherein the storage capacitor stores a voltage according to a difference between the data signal and a common signal, and the common signal is stable at the second time point.

2. The control method as claimed in claim 1, wherein the difference between the first and the second time points exceeds 10 us.

3. The control method as claimed in claim 2, further comprising:
stopping providing the data signal at a third time point; and
stopping providing the scan signal at a fourth time point.

4. The control method as claimed in claim 3, wherein the difference between the third and the fourth time points exceeds 10 us.

5. An electronic system, comprising:
a gate driver providing a scan signal at a first time point;
a source driver providing a data signal at a second time point, wherein the first time point is different from the second time point; and
a plurality of pixel units, each storing a voltage according to the difference between the data signal and a common signal, wherein the common signal is stable at the second time point.

6. The electronic system as claimed in claim 5, wherein the difference between the first and the second time points exceeds 10 us.

7. The electronic system as claimed in claim 6, wherein the source driver stops providing the data signal at a third time point and the gate driver stops providing the scan signal at a fourth time point.

8. The electronic system as claimed in claim 7, wherein the difference between the third and the fourth time points exceeds 10 us.

9. The electronic system as claimed in claim 5, wherein the electronic system is a personal digital assistant (PDA), a mobile phone, a digital camera (DSC), a television, a global positioning system (GPS), a car display, a avionics display, digital photo frame, a notebook computer (NB), or a personal computer (PC).

10. The electronic system as claimed in claim 5, wherein the gate driver, the source driver, and the pixel units are integrated into a display panel.

11. The electronic system as claimed in claim 10, further comprising a power converter for transforming an external signal into a power signal provided to the display panel.

12. The electronic system as claimed in claim 11, wherein the external signal is an alternating current (AC) signal.

13. The electronic system as claimed in claim 11, wherein the external signal is a direct current (DC) signal.

14. The electronic system as claimed in claim 13, further comprising a battery providing the DC signal.
